(19) United States
(12) Patent Application Publication
(10) Pub. No.: US 2015/0063145 A1
(43) Pub. Date: Mar. 5, 2015

(54) RADIO MEASUREMENT REPORTING

(71) Applicant: NEC Corporation, Tokyo (JP)

(72) Inventors: Caroline JACTAT, Berkshire (GB); Lanto RAKOTOHARISON, Berkshire (GB); Hisashi FUTAKI, Tokyo (JP)

(21) Appl. No.: 14/472,123

(22) Filed: Aug. 28, 2014

(30) Foreign Application Priority Data
Aug. 29, 2013 (GB) 1315395.2

(51) Int. Cl. H04W 24/02

(52) U.S. Cl. CPC H04W 24/02
USPC 370/252

(57) ABSTRACT

The present invention provides for a mobile radio communications device arranged to operate according to a first radio access technology for communication in a mobile radio communications network, and according to a second radio access technology, and to related network device and methods of operation, whereby radio measurements taken by the mobile radio communications device in relation to the first radio access technology can be polluted by coexistence interference from the second radio access technology, the mobile radio communications device being arranged to indicate to the network its capability of providing enhanced radio measurements taken while experiencing pollution by coexistence interference prior to any such provision and, if to be provided, to include interference information.

### INCORPORATION BY REFERENCE

This application is based upon and claims the benefit of priority from United Kingdom patent application No. 1315395.2, filed on Aug. 29, 2013, the disclosure of which is incorporated herein in its entirety by reference.

### BACKGROUND OF THE INVENTION

1. Technical Field

The present invention relates to radio measurement reporting as arising in a mobile radio communications device operating in a mobile radio communications network and, in particular, to such a mobile device, a related network device and methods of operation.

2. Background Art

In one particular example, the invention relates to radio measurements reported by a User Equipment (UE or terminal equipment) which can be the subject of multiple on-going active LTE (Long Term Evolution) and non-LTE radio technologies. Non-limiting examples of non-LTE radio technologies comprise ISM (Industrial, Scientific and Medical radio bands) or GNSS (Global Navigation Satellite System), the transceivers and receivers for which are employed within a common UE device. Such a UE can experience so called IDC (In-Device Coexistence) interference problems caused by one radio system on the other.

It is known from 3GPP mobile standardisation discussion documents such as RP-121791 that further enhancements are desirable for network planning measurements, such as Minimisation of Drive Tests (MDT), and relating to the enhanced interpretation of data collected from User Equipment devices. This can include the improved management of any operational interference that may be experienced.

Interference problems arising, such as from IDC, can cause various problems. In the context of MDT, involving the management of UE based network performance measurements for Long Term Evolution (LTE) radio technology, the UE's radio measurements may be collected in an environment polluted by IDC interference. This can prove problematic to a network operator seeking to optimize network performance (e.g. to detect radio coverage holes) and seeking to achieve improved radio network planning.

Also, and in relation to mobility management for a dual LTE and ISM UE device moving within a network environment, radio mobility problems can arise due to IDC interference. In particular, the control of a handover procedure from one cell to another can be disadvantageously affected.

Compensation for interference such as arising from IDC, and in particular for MDT purposes, is known from published international patent application WO2013026192A1 which document proposes that measurements polluted by IDC are tagged as “polluted” when delivered to the network, and UE/NW filtering mechanisms are then employed in relation to the tagged measurements.

However, such known handling of interference problems, for example within a UE device, and such as arising from IDC, are disadvantageously limited particularly in relation to the data and signalling required to compensate for the IDC interference.

### SUMMARY

The present invention seeks to provide for a mobile radio communications device, related network device and methods of operation thereof, having advantages over known such devices and methods.

In a first exemplary aspect of the invention, there is provided a mobile radio communications device including: a transceiver circuitry arranged to operate according to a first radio access technology in a mobile radio communications network, and a second radio access technology, and a controller arranged to indicate to the network its capability to provide radio measurements; wherein when the radio measurements taken by the controller in relation to the first radio access technology, which measurements can be polluted by coexistence interference from the second radio access technology, the controller indicates to the network its capability of providing enhanced radio measurements taken while experiencing pollution by coexistence interference prior to any such provision and, if to be provided, to include interference information.

In a second exemplary aspect of the present invention, there is provided a method of operating a mobile radio communications device capable of communicating with a first radio access technology for communications with a mobile radio communications network and a second radio access technology, the method comprising—taking radio measurements by the device in relation to the first radio access technology, which measurements can be polluted by coexistence interference from the second radio access technology, indicating to the network its capability of providing enhanced radio measurements taken while experiencing pollution by coexistence interference prior to any such provision and, if to be provided, to include interference information.

In another exemplary aspect of the present invention, there is provided a mobile radio communications network device including: a transceiver circuitry arranged to receive radio measurements from a mobile radio communications device operating according to a first radio access technology in a mobile radio communications network and a second radio access technology, and a controller arranged to monitor the capability of the mobile radio communications device providing radio measurements polluted by coexistence interference between the first and second radio access technologies.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

The invention is described further hereinafter, by way of example only, reference to the accompanying drawings in which:

FIG. 1 is a schematic representation of a mobile radio communications network including a coexisting non-network radio technology;

FIG. 2 is a schematic signalling diagram indicating the measurement and reporting between mobile radio communication devices and a network for MDT measurements;

FIG. 3 is a schematic representation of signal quality experienced by a UE device during connected mode mobility between adjacent cells of a network;

FIG. 4 is a schematic signalling diagram of one example of an embodiment of the present invention for the management of possibly polluted measurements from a UE device;

FIG. 5 is a similar schematic signalling diagram and relating to MDT measurements subsequent to the signalling of FIG. 4;

FIG. 6 is a schematic signalling diagram of an example of a further embodiment of the present invention including the provision of interference information relating to polluted measurements;

FIG. 7 is a schematic diagram of a mobile radio communications device according to an embodiment of the present invention; and

FIG. 8 is a schematic diagram of a mobile radio communications network device according to an embodiment of the present invention.

### EXEMPLARY EMBODIMENT

According to a first aspect for the present invention, there is provided a mobile radio communications device arranged to operate according to a first radio access technology for communication in a mobile radio communications network, and according to a second radio access technology, whereby radio measurements taken by the device in relation to the first radio access technology can be polluted by coexistence interference from the second radio access technology, the device being arranged to indicate to the network its capability of providing enhanced radio measurements taken while experiencing pollution by coexistence interference prior to any such provision and, if to be provided, to include interference information.

The invention can prove particularly advantageous insofar as an indication as to whether or not the UE device is capable of providing measurements polluted by interference provides for a far more efficient signalling arrangement insofar as there is no need to provide a specific tag to each measurement. Yet further, the provision of interference information such as pollution rate, or pollution level, allows the network to handle the measurements from the UE device as required, and in particular, with regard to mobility measurements and handover requirements.

Preferably, the mobile radio communications device can be arranged to provide the said radio measurements after confirming a capability of providing enhanced measurements while experiencing pollution by coexistence interference, and subsequent to receipt of a prompt from the network that only non-polluted radio measurements are required.

In particular, the said capability can be provided as an access stratum radio capability.

Further, the capability can be arranged to be provided to the radio access network of the mobile radio communications network and provided within a device set-up request.

In particular, the radio capabilities can comprise one or more of the capability of providing enhanced measurements while experiencing pollution by coexistence interference, or setting the existence of current capability or providing a coexistence interference feature group indicator.

Preferably, the said interference information can comprise one of an interference rate or interference level.

In particular, the interference information can be represented as a percentage of the measurements polluted by coexistence interference.

Further, the said percentage of measurements polluted can be determined during idle period arising according to the first radio access technology.

Yet further, the interference information can be derived with reference to a possible period of denial for the second radio access technology during the said idle period.

Still further, the interference information can be provided in a bit-map format.

Advantageously, the capability of providing such enhanced radio measurements while experiencing pollution by coexistence interference is arranged to be employed in relation to network analysis.

That is, such network analysis can advantageously comprise Minimization of Drive Test (MDT) measurements.

Further, the interference information can be arranged to be provided in relation to mobility management of the mobile radio communications device within the mobile radio communications network.

In particular, the interference information can be provided so as to assist with control of a handover procedure within the mobile radio communications device moving from one cell to another within a cellular mobile radio communications network.

It will be appreciated that one example of a mobile radio communications device of the invention can comprise a User Equipment (UE) handset. Further, the said first radio access technology can comprise LTE technology and the said second radio access technology can comprise a non-LTE technology.

Further, the second radio access technology can comprise, for example, one or more of Industrial, Scientific and Medical (ISM) radio bands or global navigation satellite system radio bands, requiring a coexistence scenario within the mobile radio communications device.

According to another aspect of the present invention, there is provided a method of operating a mobile radio communications device according to a first radio access technology for communications with a mobile radio communications network, and according to a second radio access technology, whereby radio measurements taken by the device in relation to the first radio access technology can be polluted by coexistence interference from the second radio access technology, and including the step of the device indicating to the network its capability of providing enhanced measurements taken while experiencing pollution by coexistence interference prior to any such provision and, if to be provided, to include interference information.

As will be appreciated from the above, the method can include the provision of the said radio measurements after confirming a capability of providing enhanced measurements while experiencing pollution by coexistence interference, and subsequent to receipt of a prompt from the network that only non-polluted radio measurements are required.

The method can include providing an indication of the said capability by way of an access stratum radio capability message.

Further, the method can include providing the capability to the mobile radio communications network within a device set-up request.

In particular, the radio capabilities provided by this aspect of the invention can comprise one or more of a capability of providing enhanced measurements while experiencing pollution by coexistence interference, the setting of the existence of current capability, or providing a coexistence interference feature group indicator.

The step of including the said interference information can comprise the inclusion of an interference rate and/or interference level.

As above, the interference information can be represented as a percentage of the measurements polluted by way of the coexistence interference.

Further, the method can include determining the said percentage value during idle periods arising in relation to connectivity with the said the first radio access technology.

Yet further, the method can include deriving the said interference information with reference to a possible period of denial for the second radio access technology during the said idle period.

Advantageously, the method can include providing the said capability information in relation to a network-analysis procedure, such as for example in relation to Minimization of Drive Test (MDT) measurements.

Yet further, the method can include providing the interference information in relation to mobility management of the mobile radio communications device within the mobile radio communications network.

In particular, the method can include the step of providing the interference information so as to assist with control of a handover procedure within the mobile radio communications device.

According to yet another aspect of the present invention, there is provided a mobile radio communications network device arranged to receive radio measurements from a mobile radio communications device operating according to a first radio access technology for communication in a mobile radio communications network, and according to a second radio access technology, the network device being arranged to monitor the capability of the said mobile radio communications device providing radio measurements polluted by coexistence interference between the first and second radio access technologies.

The network device can be arranged also to receive interference information along with any polluted measurements.

Advantageously, the network device can also be arranged to provide for mobility management of the mobile radio communications device on the basis of interference information received from the said device.

In particular, the mobility measurement can comprise a handover procedure.

Further, the network device can be arranged to select only devices indicating a capability of providing enhanced measurements while experiencing pollution by coexistence interference.

Yet further, the network device can be arranged to discard measurements from devices indicating a capability of providing such enhanced radio measurements while experiencing pollution by coexistence interference.

Of course it should be appreciated that the network device can be arranged to receive capability information such as that provided by a mobile radio communications device as noted above.

According to a further aspect of the present invention there is provided a method of operation within a mobile radio communications network device and including receipt of information from the mobile radio communications device indicating a capability of providing radio measurements polluted by coexistence interference between a first radio access technology and a second radio access technology within the mobile radio communications device.

The method can include the step of selecting measurements from a device responsive to the said indication of capability.

Further, the method can include the step of discarding radio measurements from a mobile radio communications device indicating a capability of providing such enhanced radio measurements while experiencing pollution by coexistence interference.

Yet further, method can include the step of controlling mobility management for the mobile radio communications device within the network and on the basis of interference information received from the mobile radio communications device.

In particular, the control of mobility management can include the control of a handover procedure for the mobile radio communications device.

The method can include steps for receiving capability information such as that provided by a mobile radio communications device as noted above.

Still further, it will be appreciated that the present invention can provide for a mobile radio communication system including a mobile radio communications device, and a mobile radio communications network device, as outlined above.

As will be appreciated, in one particular example, the invention can provide for the introduction of specific data/information and mechanisms allowing, for example, a UE terminal to indicate whether or not it might include radio measurements polluted by IDC interference, and to indicate such capability to the network. The network is then able to infer first whether or not it can select that UE terminal for radio measurements for MDT purposes and/or secondly whether or not it has to discard the radio measurements for MDT purposes. The UE terminal can also indicate interference data/information such as, for example, an IDC interference rate or IDC interference level (i.e. low/medium/high IDC interference rate level defining a set of IDC interference rates) (along with the reported measurements) to the network and allowing network configuration towards the UE to report such information.

Thus, on the basis of the above, the network can select a UE for MDT radio measurements if it knows that the UE is capable of providing IDC-free measurements (by virtue of the UE indicating the new capability). Otherwise the network can discard the UE radio measurements if the UE has not indicated such capability because the measurements could be polluted with IDC interference. Also the network would not discard measurements for which no IDC pollution was included by the UE. Hence in both cases the real network coverage perception, such as for example for planning purposes, would not be impacted.

As regards mobility management, the network can improve the connected mode mobility of those UEs that have indicated the IDC interference rate level (i.e. low/medium/high IDC interference rate level) by taking into consideration such interference in the event trigger thresholds for mobility detection.

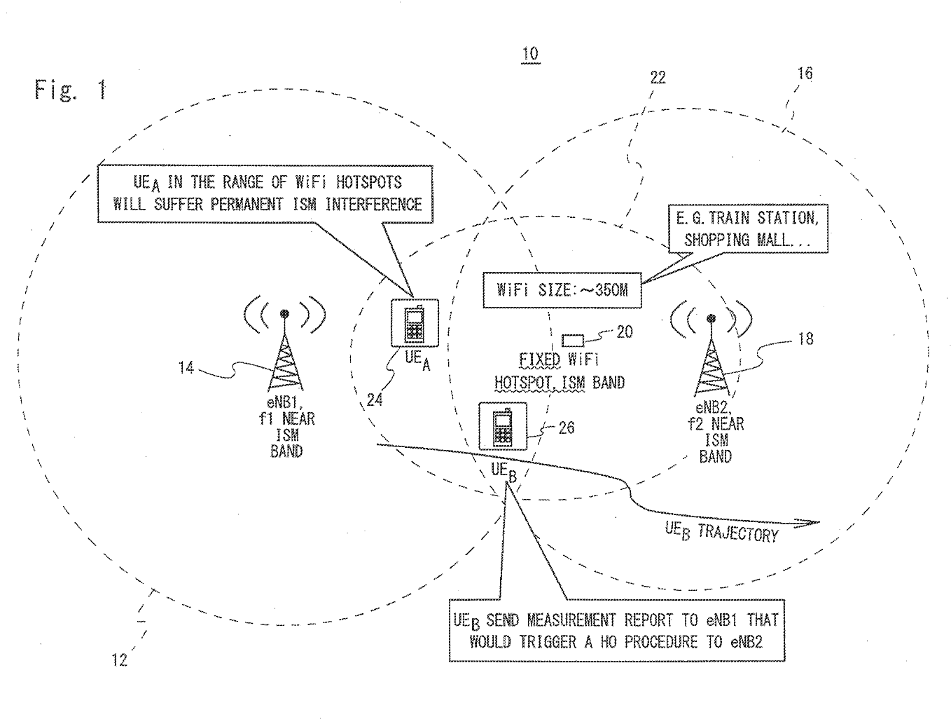

Turning first to FIG. 1, there is illustrated a region of a mobile radio communications network 10 comprising a first cell 12 and its associated base station 14, and an adjacent cell 16 and its associated base station 18.

The network and related mobile and network devices are illustrated and discussed in the context of a LTE network environment but it should be appreciated that the invention is not so limited.

That is, the invention can find use in relation to any format of communications system whether 3GPP or otherwise.

Within the environment comprising the adjacent cells 12, 16, there is provided a further region associated with a wireless router 20 defining a WiFi hotspot 22. This, for example, can comprise Industrial, Scientific and/or Medical (ISM) radio bands which are close to the respective frequency bands of the base stations 14, 18.

Also illustrated within FIG. 1 are first 24 and second 26, UE devices both of which are arranged for dual mode operation in accordance with both a first radio access technology representative of the network 10, and also, for example ISM radio bands of the hotspot 22. As such, the UE devices 24, 26 are arranged with transceivers/receivers offering connectivity to both the network 10 and the hotspot 22. In-Device Coexistence (IDC) is therefore an issue for each of the UE devices 24, 26 and which can lead to interference problems caused by one radio system on the other, and which is commonly referred to as IDC interference.

Within FIG. 1, the UE device 24, which is stationary, can suffer from IDC interference problems in the form of permanent ISM interference arising from the WiFi router 20. The UE 24 thus experiences infected reception of LTE signals due to IDC. Accordingly, the measurements performed and reported by such UE to the network operator, such as for MDT purpose, will not reflect true network coverage. The second UE device 26 however, which is moving within the network area 10 along a trajectory indicated by arrow 28, can also experience radio mobility problems due to ISM interference. Thus, for connected mode mobility, the measurement event detection, such as for a handover procedure, can be delayed due to the deterioration in detection of the target cell due to the IDC.

To overcome such problems, the present invention provides for the introduction of indicators allowing the UE to consider radio measurements in the context of IDC interference and to indicate such capability to the network so that the network is able to infer whether or not it is to select the UE radio measurements for MDT purposes. Also, if infected measurements are likely to be received from the UE, the invention can indicate the IDC interference rate (along with the reported measurements set) to the network. Accordingly, network configuration towards the UE can report such information so that the network is able to improve UE mobility when experiencing IDC interference.

As noted above therefore in relation to FIG. 1, interference problems can arise for the first UE device 24 when seeking to provide accurate radio measurements, such as for MDT purposes. It is known for example that MDT allows for the support of the autonomous collection of UE radio measurements using a control plane architecture, for example Radio Resource Control protocol for E-UTRAN. The network operator can then seek to optimise network performance by detecting coverage weaknesses and so as to allow improved network planning.

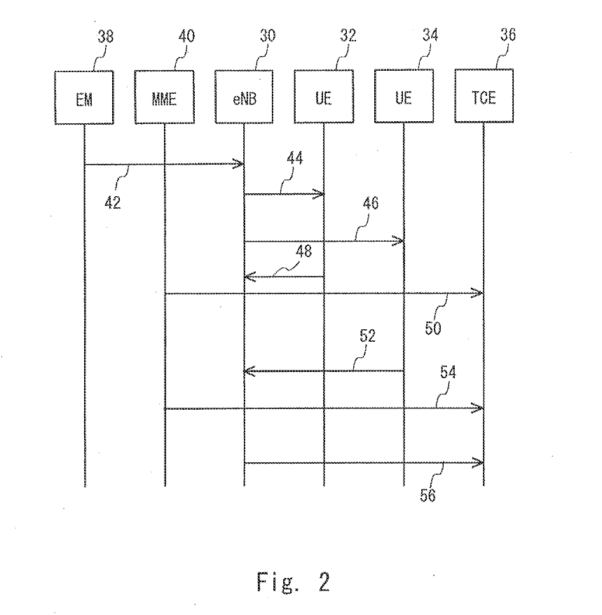

MDT within LTE networks is well known for such network planning and includes signalling arising as illustrated with reference to FIG. 2. In particular FIG. 2 illustrates signalling arising in relation to a network connection such as a network base station (eNB) 30, responsible for selecting UE devices for participating in MDT measurements and for configuring the relevant MDT measurements towards the UE devices of which two 32, 34 are illustrated. Also provided is a Trace Collection Entity (TCE) 36 comprising a network entity arranged for collecting the UE measurements as received from the eNB 30. If required, the TCE 36 can be located with an element manager (EM) 38 comprising a network management entity arranged for configuring functions within the network elements, including the UE MDT measurements in the eNB 30. A mobile management entity (MME) 40 of the network is also illustrated.

As indicated, signalling 42 is first provided from the element manager 38 to the eNB 30 and seeking to provide trace session activation and which includes UE measurement configuration information. A trace session is then commenced within the eNB 30 which includes the storage of trace parameters, and the capabilities of each of the UE devices 32, 34 are then retrieved. UE device selection is then conducted based on the device capability requirements as received from the element manager 38 and trace activation/UE measurement configuration signals 44, 46 are delivered from the eNB 30 to the UE devices 32, 34 respectively.

Appropriate measurements are then conducted within each of the UE devices 32, 34 and a first UE measurement report 48 is provided via Radio Resource Control from the UE device 32 to the eNB 30. The Mobile Management Entity 40, on the basis of the UE measurement report 48 received at the eNB 30, obtains the relevant subscriber identity information, which identities are then provided by way of signalling 50 to the TCE.

Within the eNB 30, the UE measurements are then saved to the relevant trace records.

A similar procedure then continues in relation to the UE device 34 with measurement reporting 52 via the RRC, subsequent retrieval of subscriber identity at the mobile management entity 40 and subscriber identities for the particular trace session are delivered by signalling 54 to the TCE 36. Again, the eNB 30 serves to save the UE measurements to the relevant trace records and can then provide trace record reporting signalling 56 to the TCE 36 which combines the trace records with the subscriber identities based on the trace reference and traced recording session references.

The TCE 36 then has sufficiently accurate information for ongoing network planning such as MDT.

However, for UE devices such as that 24 illustrated in FIG. 1, IDC interference problems can prove particularly problematic in relation to the measurement reporting signalling 48, 52 illustrated in FIG. 2 since the measurements conducted at the UE can be polluted by IDC interference.

Interference experienced by, for example, the UE device 24 of FIG. 1 can have an impact on radio resource management because of its effect on the reception of LTE signals. This in turn, has an impact on real network coverage perception given that the current radio measurements sent by the UE do not take into account interference from other non-3GPP radio access technologies, such as the WiFi hotspot 22 of FIG. 1.

Remaining with FIG. 1, and referring in particular to the second UE device 26 following its path of movement 28 within the network 10 environment illustrated, interference experienced by the UE device 26, and arising due to IDC issues, also impacts on UE connected mode mobility, such as cell handover procedures. For example, the radio measurement event detection that initiates handover can be delayed due to the deteriorated detection of the target cell signal quality due to IDC and insofar as the current event trigger threshold does not take account of the coexistence with other non-3GPP radio access technologies, such as, for example, WiFi and Bluetooth etc.

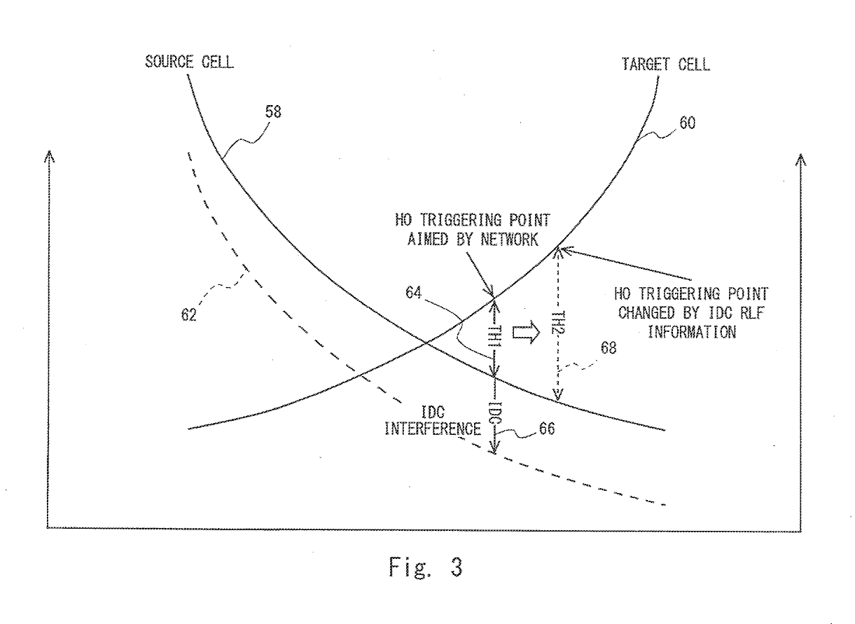

Such a problem is illustrated with reference to FIG. 3 in which the vertical axis represents received signal quality with distance along the horizontal axis, from a source cell 58, and a target cell 60. Also represented is an interference signal 62 from a non-3GPP radio access technology.

While a normal handover triggering point 64 would arise without any interference due to a handover threshold 64 TH1 being reached, the pollution from the interference signal 62 serves to shift the threshold to a “TH1+IDC” value 66 such that the actual handover threshold TH2 is then reached at a delayed time 68 serving to disadvantageously delay the time at which handover to the target cell 60 occurs. The existence of the interference signal 62 therefore disadvantageously serves to delay handover from the point in time when it might otherwise have occurred.

Advantageously, within the context of the present invention, the provision of interference information which can comprise interference rate, or interference level, information, allows the network to compensate for such interference and determine a more appropriate handover and thereby provide appropriate handover control, and general mobility management, for UE devices experiencing IDC interference.

Further illustrations of the present invention are now provided with reference to further signalling diagrams.

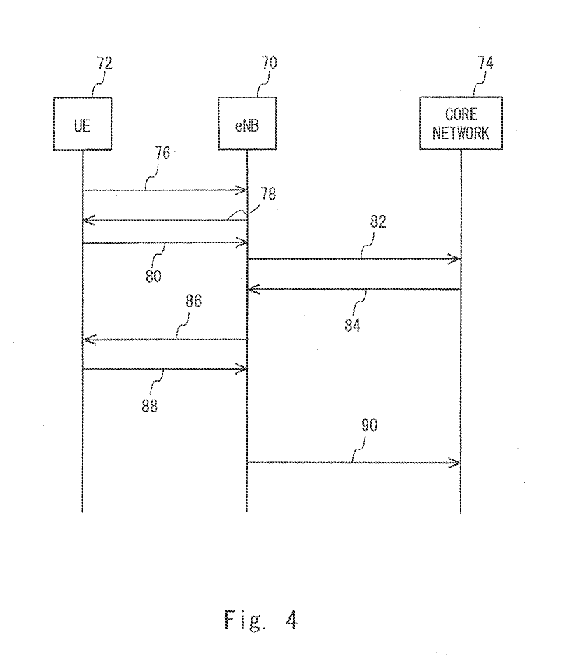

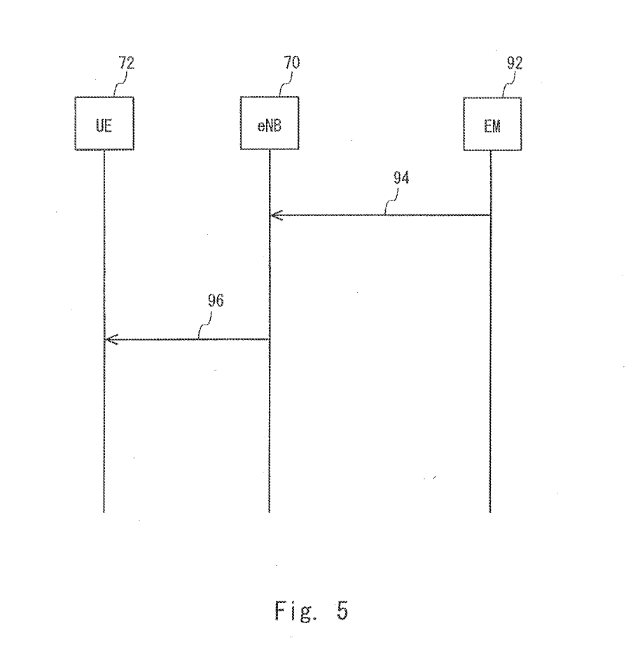

A first illustrated example arises when the operator may not wish to collect those measurements that are polluted by IDC interference because the operator categorizes in-device coexistence problem as a problem local to the UE, and also since it is considered that the IDC problem should not interfere with global network coverage issues. This approach is depicted in FIGS. 4 and 5. Here, the UE capability of providing enhanced MDT measurements in the presence of IDC pollution would allow the network to select only those UE devices that will not provide IDC-polluted MDT measurements when such measurements need to be collected.

FIG. 4 provides a schematic signalling diagram concerning the exchange of UE Access Stratum (AS) radio capabilities as arising during first registration to the Core Network in accordance with an embodiment of the present invention and illustrated in relation to a radio access network device such as eNB 70, a UE device 72 and Core Network 74.

The signalling exchange commences with an RRC connection request signal 76 from the UE 72 to the eNB 70 and which device responds with a RRC connection setup signal 78. The UE 72 then signals 80 that the RRC setup connection is complete and the eNB 70 in turn delivers an initial UE message, such as for example a Non-Access Stratum (NAS) PDU message 82, to the Core Network 74. The Core Network 74 can then reply to the eNB 70 with a request 84 for initial UE context setup.

In the absence of UE AS capabilities received from the Core Network 74 (since this is the first connection to the core network 74) the eNB 74 can then send a request for AS capabilities towards the UE 72 by way of a RRC UE capability enquiry 86.

According to an advantageous feature of this illustrated embodiment of the invention, an RRC UE capability signal 88 is then delivered from the UE 72 to the eNB 70. This can include UE AS capabilities including an indication of the capability of providing enhanced MDT measurements while experiencing IDC pollution, or that existing MDT/IDC capabilities are set, or the provision of an MDT/IDC feature group indicator.

The UE capability information is then sent onward from the eNB 70 to the Core Networks 74 as UE capability information indication signal 90. It should then be appreciated that the AS radio capabilities to be stored by the CN are enhanced with the capability of providing enhanced MDT measurements while experiencing IDC pollution, or that existing MDT/IDC capabilities are set, or the provision of an MDT/IDC feature group indicator. Such indications can be provided to the RAN in the Initial UE Context Setup Request message whenever the UE gets connected to the RAN and so that the RAN does not need to perform the RRC UE capability enquiry procedure again.

Turning now to FIG. 5, there is provided an illustration of ongoing signalling in relation to this embodiment of the present invention and relating to MDT measurement activation.

The network entities now concerned comprise the eNB 70 and UE 72 and also an element manager (EM) 92.

The illustrated signalling commences when the element manager 92 first decides to trigger the UE radio measurements, for example, for MDT purposes from the eNB 70 and so delivers a trace session activation signal 94 to the eNB 70. In this example, the operator wishes to obtain measurements without IDC interference and so, as noted, an IDC polluted measurement flag can be set to “OFF” so that UEs that remain capable of IDC pollution will not be selected for MDT measurement reporting. In further detail, the trace session activation 94 can comprise:

(UE measurement configuration={list of UTRAN/E-UTRAN radio cells, device capability requirements (e.g. minimum battery status etc.), IDC polluted measurements flag=OFF. List of measurements (e.g. measured radio reception levels pertaining to the considered radio technology (RSRP—Reference Signal Received Power—/RSRQ—Reference Signal Received Quality—for LTE)), list of reporting triggers depending on the measured events (e.g. periodic for RSRP/RSRQ measurements), reporting interval (for immediate MDT only), reporting amount (for immediate MDT only), event threshold (for immediate MDT only), logging interval (for logged MDT only), logging duration (for logged MDT only).

Subsequent to receipt of the trace session activation signal 94, and if the RAN (i.e. eNB 70) has been configured to collect measurements without IDC interference, it checks whether “capability of providing enhanced MDT measurements while IDC pollution” or “existing MDT/IDC capabilities are set” or “MDT/IDC feature group indicator” is part of the UE context. If so, the RAN selects such UE and configures it so that it does not include IDC polluted measurements along with MDT measurements.

Subsequently, a logged measurement configuration signal 96, including measurements configuration, is delivered from the eNB 70 to the UE 72 and such a UE 72 having “capability of providing enhanced MDT measurements while IDC pollution” or “existing MDT/IDC capabilities are set” or “MDT/IDC feature group indicator” will not then include MDT measurements or Radio Link Failure (RLF) report measurements while IDC interference occurs.

As will therefore be appreciated, and through efficient signalling, only devices that are capable of providing unpolluted measurement signals, are employed within the network for MDT purposes.

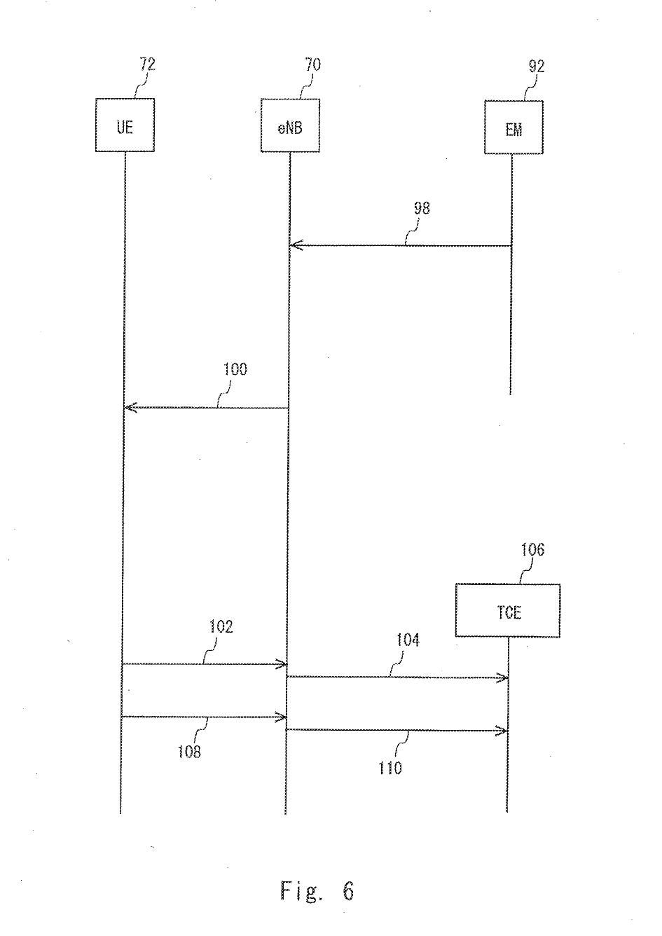

A further aspect of the invention arises in scenarios in which the operator may wish to collect those measurements that are polluted by IDC interference, for example to improve UE mobility in such situations. This approach is depicted in FIG. 6. and the UE capability of providing enhanced MDT measurements while experiencing IDC pollution allows the network to request the UE to include, for example, the rate of IDC interference along with polluted measurements if any. Alternatively, the network can include an IDC interference rate threshold so that the UE would report measurements only if the IDC interference does not exceed the threshold value.

In one example, the IDC interference rate is provided in a bit-map format where a least significant bit (bit0) would be set if less than 20% of the measurements have IDC interference, and bit1 (at the leftside of bit0) would be set if less than 40% of the measurements have IDC interference etc.

The following is one example of UE implementation to assess the IDC interference rate while performing measurements. The UE performs the measurements during LTE idle periods and during such a period the UE can be arranged to use another radio access technology causing IDC interference. To avoid such interference, the UE can deny transmission or reception from the other radio access technology in which case measurements performed while such denial is possible would not be subject to IDC interference. Then the IDC interference rate would be computed as follows: (measurements period—other radio denial period)/measurements period.

Further detailed examples are as follows. Assuming the UE has a 5 ms idle period of LTE to perform measurements and the UE can deny the other radio during 2 ms while in this idle period then the IDC interference rate would be 60% i.e. (5 ms-2 ms)/5 ms. Assuming the next idle period of LTE is 4 ms and the UE can deny the other radio during 1 ms while in this idle period then the IDC interference rate would be 75% i.e. (4 ms-1 ms)/4 ms. If the UE has to report the previous two measurements then it would provide an aggregated IDC interference rate which would be [((5 ms+4 ms)−(2 ms+1 ms))/(5 ms+4 ms)] i.e. 66%.

Turning now to FIG. 6, there is provided an illustration of a signalling exchange in which IDC interference information is specifically provided along with the measurement signals so that ongoing control, such as mobile mobility management and related handover management within a cellular environment, can be achieved. The IDC interference then has a reduced impact on the handover procedure.

The signalling is illustrated again in relation to eNB 70 and UE 72 and also in relation to a TCE 106 such as that of FIG. 2, and an element manager (EM) 92, such as that of FIG. 5.

Prior to MDT measurement activation, a UE AS radio-capabilities-exchange occurs in relation to the Core Network and in the same manner as illustrated with reference to FIG. 5.

Within the MDT measurement activation portion of the signalling, the element manager 92 first decides to trigger the UE radio measurement for MDT purposes from the eNB 70 and so issues to trace session activation signal 98 including an indication that the operator wishes to obtain measurements with IDC interference such that, as illustrated below, the IDC polluted measurement flag is set “ON”.

The trace session activation 98 can then comprise:

(UE measurement configuration={list of UTRAN/E-UTRAN radio cells, device capability requirements (e.g. minimum battery status etc.), IDC polluted measurements flag=ON. List of measurements (e.g. measured radio reception levels pertaining to the considered radio technology (RSRP—Reference Signal Received Power—/RSRQ—Reference Signal Received Quality—for LTE)), list of reporting triggers depending on the measured events (e.g. periodic for RSRP/RSRQ measurements), reporting interval (for immediate MDT only), reporting amount (for immediate MDT only), event threshold (for immediate MDT only), logging interval (for logged MDT only), logging duration (for logged MDT only).

At the eNB 70, if the RAN has been configured to collect measurements without IDC interference, it checks whether “capability of providing enhanced MDT measurements while IDC pollution” OR “existing MDT/IDC capabilities” are set OR “MDT/IDC feature group indicator” is part of UE context. If so, the RAN selects such UE and configures it so as to include IDC interference level ranges along with MDT measurements.

A logged measurement configuration signal 100 is then delivered from the eNB 70 to the UE 72 and which can comprise measurement configuration including IDC interference rate configuration and/or including IDC interference rate level information.

On the basis of “IDC interference rate” information, the UE can include the IDC interference rate along with further MDT measurements or RLF report measurements.

Alternatively, on the basis of “IDC interference rate level” information, the UE can include IDC interference rate along with those further MDT measurements, or RLF report measurements, for which IDC interference would not exceed such “IDC interference rate level”.

The UE 72 can then respond with a logged measurement signal 102, including relevant measurements and the IDC interference rate, which in turn, by way of signalling 104, is delivered from the eNB 70 to the TCE 106.

Likewise, RLF report measurement signalling 108, delivered from the UE 72 to the eNB 70 can include RLF measurements and an indication of IDC interference rate, which information is then delivered from the eNB 70 to the trace collection entity 106.

It should be appreciated that the TCE 106 may filter the measurements to identify just those including the lowest IDC interference rate.

Appropriately, the network can further update the received quality threshold used for a handover triggering point.

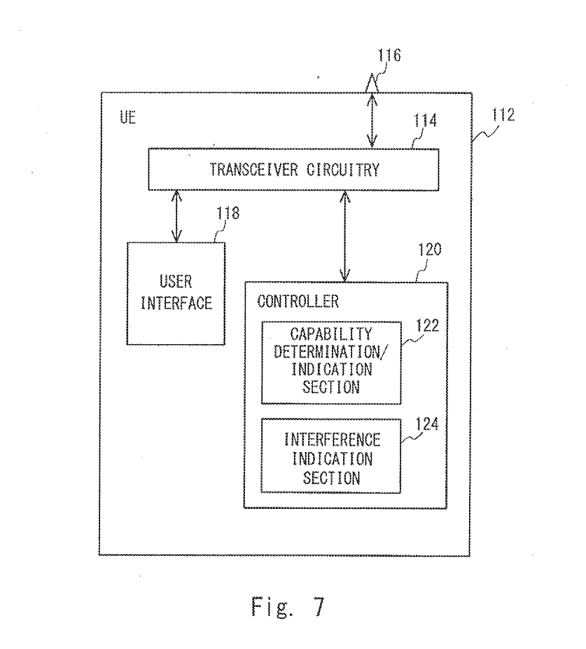

Turning now to FIG. 7, there is provided a schematic representation of a mobile radio communications device such as a UE handset 112 including transceiver circuitry 114 operatively connected as shown to an antenna 116 and also operatively connected as shown to a user interface 118 and a controller 120.

The UE 112 is arranged both for LTE connectivity and ISM connectivity and the transceiver circuitry 114 schematically represented includes transceiver functionality for such dual mode operation. IDC interference is therefore an issue for the UE 112.

In accordance with an embodiment of the present invention, the controller 120 includes a capability determination/indication section 122 allowing the UE 112 to determine its capability for conducting radio measurements, and the capability of the provision of radio measurements, within an environment experiencing IDC interference. The controller 120 also includes an interference indication section 124 providing for the determination and signalling of interference information, such as interference rate and/or interference level. If it is determined through network control that the UE 112 is to deliver a signal including radio measurements, while experiencing such interference, then the interference indication section 124 can provide such information.

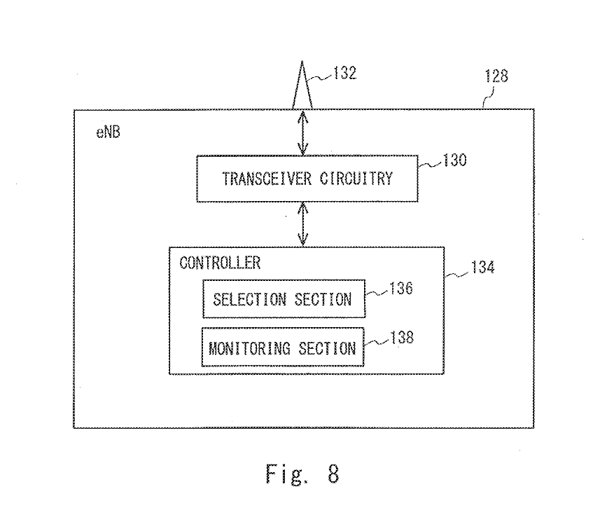

Turning now to FIG. 8, there is provided a schematic representation of a mobile radio communications network device such as, for example, an eNB 128 of an LTE network and including transceiver circuitry 130 operatively connected to an antenna 132 and a controller 134.

Within the illustrated embodiment of the eNB 128, the controller 134 includes a selection section 136 arranged for controlling selection of which of a variety of UE devices, such as UE 112, the network might obtain radio measurements from and having regard to the capability indicators discussed above. The controller 134 further includes a monitoring section 138 by means of which the eNB 128 can monitor the capabilities of UE devices, such as UE 112, and to receive radio measurements obtained in an environment including IDC interference and, further, if required, to determine the rate and/or level of such interference. As required, the respective functional sections 136, 138 of the controller 134 can be employed for MDT analysis and handover procedures respectively.

It should however be appreciated that the invention is not restricted to the specific details of the embodiments illustrated with reference to FIGS. 7 and 8. In particular, the devices of the present invention can be employed for connectivity in accordance with any appropriate radio technology and related mobile radio communications network.

As should be further appreciated, in both illustrated aspects of the invention, the RAN can be configured whether or not to collect MDT measurements polluted by IDC interference. The capability information can comprise UE radio resource control (RRC) capability or UE setting of existing UE MDT/IDC capabilities or MDT/IDC feature group indicator serving to indicate whether the UE can provide MDT measurements in the context of IDC interference. On the basis of such Information, the RAN can select an UE having the ability to provide MDT measurements or RLF measurements in the context of IDC interference. Further, the RAN can configure the UE to provide IDC interference rate or IDC interference rate level (i.e. low/medium/high) along with IDC polluted MDT measurements or IDC polluted RLF measurements. Based on such Information, the RAN can adapt the handover triggering event threshold to the UE, and the TCE can filter the MDT measurements according to their IDC interference rate, i.e. if the latter is above a certain threshold.

The whole or part of the exemplary embodiments disclosed above can be described as, but not limited to, the following supplementary notes.

(Supplementary note 1) A mobile radio communications device arranged to operate according to a first radio access technology for communication in a mobile radio communications network, and according to a second radio access technology, whereby radio measurements taken by the device in relation to the first radio access technology can be polluted by coexistence interference from the second radio access technology, the device being arranged to indicate to the network its capability of providing enhanced radio measurements taken while experiencing pollution by coexistence interference prior to any such provision and, if to be provided, to include interference information.
(Supplementary note 2) A device as claimed in Supplementary note 1, and arranged to provide the said radio measurements after confirming a capability of providing the said enhanced measurements and subsequent to receipt of a prompt from the network that only non-polluted radio measurements are required.
(Supplementary note 3) A device as claimed in Supplementary note 1 or 2, and arranged to provide the said capability as an access stratum radio capability.
(Supplementary note 4) A device as claimed in Supplementary note 1, 2 or 3, and arranged to provide the said capability within a device radio connection set-up request.
(Supplementary note 5) A device as claimed in any one or more of the preceding Supplementary notes, wherein the radio capabilities comprise one or more of a capability of providing the said enhanced measurements, or setting the existence of current capability or providing a coexistence interference feature group indicator.
(Supplementary note 6) A device as claimed in any one or more of the preceding Supplementary notes, wherein the said interference information comprises at least one of an interference rate or interference level.
(Supplementary note 7) A device as claimed in any one or more of Supplementary notes 1 to 6, wherein the interference information is represented as a percentage of the measurements polluted by coexistence interference.
(Supplementary note 8) A device as claimed in Supplementary note 7, wherein the said percentage of measurements polluted is determined during an idle period arising according to the first radio access technology.
(Supplementary note 9) A device as claimed in Supplementary note 8, wherein the interference information is derived with reference to a possible period of denial for the second radio access technology during the said idle period.
(Supplementary note 10) A device as claimed in any one or more of the preceding Supplementary notes, wherein the interference information is provided in a bit-map format.
(Supplementary note 11) A device as claimed in any one or more of the preceding Supplementary notes wherein the interference information is provided in relation to mobility management of the mobile radio communications device within the mobile radio communications network.
(Supplementary note 12) A device as claimed in any one or more of the preceding Supplementary notes wherein the said first radio access technology comprises LTE technology, and the said second radio access technology comprises a non-LTE technology.
(Supplementary note 13) A device as claimed in any one or more of the preceding Supplementary notes wherein the second radio access technology comprises one or more of industrial, scientific and medical radio bands or global navigation satellite system radio bands.
(Supplementary note 14) A method of operating a mobile radio communications device according to a first radio access technology for communications with a mobile radio communications network, and according to a second radio access technology, whereby radio measurements taken by the device in relation to the first radio access technology can be polluted by coexistence interference from the second radio access technology, and including the step of the device indicating to the network its capability of providing enhanced radio measurements taken while experiencing pollution by coexistence interference prior to any such provision and, if to be provided, to include interference information.
(Supplementary note 15) A method as claimed in Supplementary note 14, and including the provision of the said radio measurements after confirming a capability of providing the said enhanced measurements, and subsequent to receipt of a prompt from the network that only non-polluted radio measurements are required.
(Supplementary note 16) A method as claimed in Supplementary note 14 or 15, and including providing an indication of the said capability by way of an access stratum radio capability message.
(Supplementary note 17) A method as claimed in Supplementary note 14, 15 or 16, and including providing the capability to the mobile radio communications network within a device radio connection set-up request.
(Supplementary note 18) A method as claimed in any one or more of Supplementary notes 14 to 17, wherein the said radio capabilities comprise one or more of a capability of providing the said enhanced, the setting of the existence of current capability, or providing a coexistence interference feature group indicator.
(Supplementary note 19) A method as claimed in any one or more of Supplementary notes 14 to 18, wherein the step of including the said interference information, comprises the inclusion of at least one of an interference rate or interference level.
(Supplementary note 20) A method as claimed in Supplementary note 19, and representing the interference information as a percentage of the measurements polluted by coexistence interference.
(Supplementary note 21) A method as claimed in Supplementary note 20, and including determining the said percentage value during idle periods arising according connectivity with the said the first radio access technology.
(Supplementary note 22) A method as claimed in Supplementary note 21, and including deriving the said interference information with reference to a possible period of denial for the second radio access technology during the said idle period.
(Supplementary note 23) A method as claimed in any one or more of Supplementary notes 14 to 22, and including providing the said capability information in relation to a network-analysis procedure.
(Supplementary note 24) A method as claimed in Supplementary note 23, wherein the said network analysis procedure includes Minimization of Drive Test measurements.
(Supplementary note 25) A method as claimed in any one or more of Supplementary notes 14 to 24, and including providing the interference information in relation to mobility management of the mobile radio communications device within the mobile radio communications network.
(Supplementary note 26) A method as claimed in Supplementary note 25, and including the step of providing the interference information so as to assist with control of a handover procedure within the mobile radio communications device.
(Supplementary note 27) A mobile radio communications network device arranged to receive radio measurements from a mobile radio communications device operating according to a first radio access technology for communication in a mobile radio communications network, and according to a second radio access technology, the network device being arranged to monitor the capability of the said mobile radio communications device providing radio measurements polluted by coexistence interference between the first and second radio access technologies.
(Supplementary note 28) A device as claimed in Supplementary note 27, and arranged also to receive interference information along with any polluted measurements.
(Supplementary note 29) A device as claimed in Supplementary note 27 or 28, and arranged to provide for mobility management of the mobile radio communications device on the basis of interference information received from the said device.
(Supplementary note 30) A device as claimed in Supplementary note 27, 28 or 29, and arranged to select only devices indicating a capability of providing unpolluted measurements.
(Supplementary note 31) As device as claimed in Supplementary note 27, 28, 29 or 30, and arranged to discard measurements from devices indicating a capability of providing such enhanced radio measurements while experiencing pollution by coexistence interference.
(Supplementary note 32) A device as claimed in any one or more of Supplementary notes 27 to 31, and arranged to receive capability information such as that provided by a mobile radio communications device as claimed in any one or more of Supplementary notes 1 to 13.
(Supplementary note 33) A method of operation within a mobile radio communications network device and including receipt of information from the mobile radio communications device indicating a capability of providing radio measurements polluted by coexistence interference between a first radio access technology and a second radio access technology within the mobile radio communications device.
(Supplementary note 34) A method as claimed in Supplementary note 33, and including the step of selecting measurements from a device responsive to the said indication of capability.
(Supplementary note 35) A method as claimed in Supplementary note 33 or 34, and including the step of discarding radio measurements from a mobile radio communications device indicating a capability of providing such enhanced radio measurements while experiencing pollution by coexistence interference.
(Supplementary note 36) A method as claimed in Supplementary note 33, 34 or 35, and including the step of controlling mobility management for the mobile radio communications device within the network and on the basis of interference information received from the mobile radio communications device.
(Supplementary note 37) A method as claimed in any one or more of Supplementary notes 33 to 36, and including steps for receiving capability information such as that provided by a mobile radio communications device as defined in any one or more of Supplementary notes 1 to 13.
(Supplementary note 38) A mobile radio communication system including a mobile radio communications device as defined in any one or more of Supplementary notes 1 to 13, and a mobile radio communications network device, as defined in any one or more of Supplementary notes 27 to 32.
(Supplementary note 39) A mobile radio communications device arranged to operate according to a first radio access technology for communication in a mobile radio communications network, and according to a second radio access technology, and substantially as hereinbefore described with reference to the accompanying drawings.
(Supplementary note 40) A method of operating a mobile radio communications device according to a first radio access technology for communications with a mobile radio communications network, and according to a second radio access technology, and substantially as hereinbefore described with reference to the accompanying drawings.
(Supplementary note 41) A mobile radio communications network device arranged to receive radio measurements from a mobile radio communications device operating according to a first radio access technology for communication with a mobile radio communications network, and according to a second radio access technology, and substantially as hereinbefore described with reference to the accompanying drawings.
(Supplementary note 42) A method of operation within a mobile radio communications network device substantially as hereinbefore described with reference to the accompanying drawings.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A mobile radio communications device comprising:
a transceiver circuitry arranged to operate according to a first radio access technology in a mobile radio communications network, and a second radio access technology, and
a controller arranged to indicate to the network its capability to provide radio measurements;
wherein when the radio measurements taken by the controller in relation to the first radio access technology, which measurements can be polluted by coexistence interference from the second radio access technology, the controller indicates to the network its capability of providing enhanced radio measurements taken while experiencing pollution by coexistence interference prior to any such provision and, if to be provided, to include interference information.

2. A device as claimed in claim 1, wherein the controller is arranged to provide the said radio measurements after confirming a capability of providing the said enhanced measurements and subsequent to receipt of a prompt from the network that only non-polluted radio measurements are required.

3. A device as claimed in claim 1, wherein the controller is arranged to provide the said capability as an access stratum radio capability.

4. A device as claimed in claim 1, wherein the controller is arranged to provide the said capability within a device radio connection set-up request.

5. A device as claimed in claim 1, wherein the radio capabilities comprise one or more of a capability of providing the said enhanced measurements, or setting the existence of a current capability or providing a coexistence interference feature group indicator.

6. A device as claimed in claim 1, wherein the said interference information comprises at least one of an interference rate or interference level.

7. A device as claimed in claim 1, wherein the interference information is represented as a percentage of the measurements polluted by coexistence interference.

8. A device as claimed in claim 7, wherein the said percentage of measurements polluted is determined during an idle period arising according to the first radio access technology.

9. A device as claimed in claim 8, wherein the interference information is derived with reference to a possible period of denial for the second radio access technology during the said idle period.

10. A device as claimed in claim 1, wherein the interference information is provided in a bit-map format.

11. A device as claimed in claim 1, wherein the interference information is provided in relation to mobility management of the mobile radio communications device within the mobile radio communications network.

12. A device as claimed in claim 1, wherein the said first radio access technology comprises LTE technology, and the said second radio access technology comprises a non-LTE technology.

13. A device as claimed in claim 1, wherein the second radio access technology comprises one or more of industrial, scientific and medical radio bands or global navigation satellite system radio bands.

14. A method of operating a mobile radio communications device capable of communicating with a first radio access technology for communications with a mobile radio communications network and a second radio access technology, the method comprising:
taking radio measurements by the device in relation to the first radio access technology, which measurements can be polluted by coexistence interference from the second radio access technology, and
indicating to the network its capability of providing enhanced radio measurements taken while experiencing pollution by coexistence interference prior to any such provision and, if to be provided, to include interference information.

15. A mobile radio communications network device comprising:
a transceiver circuitry arranged to receive radio measurements from a mobile radio communications device operating according to a first radio access technology in a mobile radio communications network and a second radio access technology, and
a controller arranged to monitor the capability of the said mobile radio communications device providing radio measurements polluted by coexistence interference between the first and second radio access technologies.

16. A device as claimed in claim 15, wherein the transceiver circuitry receives interference information along with any polluted measurements.

17. A device as claimed in claim 15, wherein the controller provides for mobility management of the mobile radio communications device on the basis of interference information received from the said device.

18. A device as claimed in claim 15, wherein the controller selects only devices indicating a capability of providing unpolluted measurements.

19. As device as claimed in claim 15, wherein the controller discards measurements from devices indicating a capability of providing such enhanced radio measurements while experiencing pollution by coexistence interference.

20. A device as claimed in claim 15, wherein the transceiver circuitry receives capability information such as that provided by a mobile radio communications device as claimed in claims 1.
